(19) United States
(12) Patent Application Publication
(10) Pub. No.: US 2010/0188052 A1
(43) Pub. Date: Jul. 29, 2010

(54) Charge Device

(75) Inventors: Sheng-Chieh Su, Taipei (TW); Jung-Tai Chen, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASUSTeK Computer Inc, Taipei (TW)

(21) Appl. No.: 12/683,765

(22) Filed: Jan. 7, 2010

(30) Foreign Application Priority Data
Jan. 23, 2009 (TW) 98102967

(51) Int. Cl. H02J 7/00

(52) U.S. Cl. 320/148; 320/150; 320/153

(57) ABSTRACT

A charge device includes a charge circuit and a monitoring circuit. The charge circuit includes a current limiting element, a rectifier element, and a DC voltage supply unit. The rectifier element is connected with the current limiting element in series. The DC voltage supply unit is used for providing a DC voltage to the battery to charge the battery via the current limiting element and the rectifier element connected with the current limiting element in series. The monitoring circuit includes a temperature sensing unit and a first control unit. The temperature sensing unit is used for sensing a surface temperature of the battery. The first control unit is used for controlling the DC voltage supply unit to stop charging the battery when the surface temperature is higher than a predetermined temperature.

This application claims the benefit of Taiwan application Serial No. 98102967, filed Jan. 23, 2009, the subject matter of which is incorporated herein by reference.

### BACKGROUND OF THE INVENTION

1. Field of the Invention

The invention relates to a charge device and, more particularly, to a charge device for charging a battery.

2. Description of the Related Art

Electronic devices are widely used. One of common electronic devices is a charge device, which is a device for charging a battery.

The charge device should stably generate a charge current provided to the battery, and it needs to limit the value of the charge current along with the increase of a battery voltage in a charge process. As a result, the battery is not damaged, and dangers are avoided.

FIG. 1 is a circuit diagram showing a conventional charge device. A charge device 100 is disclosed in a published utility model patent whose publication number is CN201051680, and the name of the patent is current auto-adjusting charger for common dry battery.

The charge device 100 includes a transformer 1, a rectifier 2, a filtering and current limiting circuit 3, a shunt circuit 4, and an anti-reverse-flow element 5. The filtering and current limiting circuit 3 includes a filter capacitor C and a current limiting resistor R1. The anti-reverse-flow element 5 is a diode. The operating principle of the charge device 100 is illustrated as follows. After the voltage of alternating Current (AC) power Vac is reduced via the transformer 1, and rectified and filtered via the rectifier 2 and the filtering and current limiting circuit 3, an output current io′ via the current limiting resistor R1 is provided. Afterwards, the output current io′ is shunted via the shunt circuit 4 to be a charge current ic′ via a reflux element 5 to charge a battery BT.

However, since not all the output current io′ provided by the charge device 100 is used for charging the battery BT, the energy utilization ratio is reduced. Thus, the charging efficiency of the charge device 100 is reduced. Consequently, how to improve the energy utilization ratio of the charge device, improve the charging efficiency, and reduce the complexity of the circuit of the charge device is a project to which the filed dedicates for.

### BRIEF SUMMARY OF THE INVENTION

The invention relates to a charge device which can improve the energy utilization of the charge device and the charging efficiency and reduce the complexity of the circuit of the charge device. Moreover, the charge device can improve the safety in charging a battery. The charge device can be realized via simple circuit without using a charge controller, and thus its cost is low.

According to an aspect of the invention, the invention provides the charge device including a charge circuit and a monitoring circuit. The charge circuit includes a current limiting element, a rectifier element, and a direct current (DC) voltage supply unit. The rectifier element is connected with the current limiting element connected in series. The DC voltage supply unit is used for providing a DC voltage to the battery to charge the battery via the current limiting element and the rectifier element connected with the current limiting element in series. The monitoring circuit includes a temperature sensing unit and a first control unit. The temperature sensing unit is used for sensing a surface temperature of the battery. The first control unit is used for controlling the DC voltage supply unit to stop charging the battery when the surface temperature is higher than a predetermined temperature.

These and other features, aspects and advantages of the present invention will become better understood with regard to the following description, appended claims, and accompanying drawings.

### BRIEF DESCRIPTION OF THE DRAWINGS

FIG. 1 is a circuit diagram showing a conventional charge device;

FIG. 2 is a block diagram showing a charge device according to an embodiment of the invention; and

FIG. 3 is a schematic diagram showing a circuit of the charge device in FIG. 2 according to an embodiment of the invention.

### DETAILED DESCRIPTION OF THE EMBODIMENTS

FIG. 2 is a block diagram showing a charge device 200 according to an embodiment of the invention. The charge device 200 includes a charge circuit 220 and a monitoring circuit 240.

The charge circuit 220 includes a current limiting element 222, a rectifier element 224, and a DC voltage supply unit 226. The rectifier element 224 is connected with the current limiting element 222 in series. The DC voltage supply unit 226 is used for providing a DC voltage Vdc to a battery 260 via the current limiting element 222 and the rectifier element 224 connected with the current limiting element 222 in series to charge the battery 260.

The monitoring circuit 240 includes a temperature sensing unit 242 and a first control unit 244. The temperature sensing unit 242 is used for sensing a surface temperature of the battery 260. The first control unit 244 is used for determining whether the surface temperature of the battery 260 is higher than a predetermined temperature.

When the surface temperature of the battery 260 is higher than the predetermined temperature, the battery 260 may be abnormal. Consequently, the first control unit 244 controls the DC voltage supply unit 226 to stop charging the battery 260 for a safety consideration.

Additionally, as shown in FIG. 2, in an embodiment of the invention, the monitoring circuit 240 may further include a voltage sensing unit 246 and a second control unit 248. The voltage sensing unit 246 is used for sensing a battery voltage Vch of the battery 260. When the battery voltage Vch is higher than a second predetermined voltage, which represents that the battery 260 is charged to a due voltage, the battery 260 does not need to be charged any more. Consequently, the second control unit 248 controls the DC voltage supply unit 226 to stop charging the battery 260 when the battery voltage Vch is higher than the second predetermined voltage.

In other words, in the process of charging the battery 260 by the charge device 200, if the temperature sensing unit 242 senses that the surface temperature of the battery 260 is abnormal (such as generating high temperature), the first control unit 244 may disable the DC voltage supply unit 226. As a result, the DC voltage supply unit 226 is controlled to stop charging the battery 260, and thus the safety in using the charge device 200 is improved.

Additionally, if the voltage sensing unit 246 senses that the battery voltage Vch of the battery 260 is abnormal (for example, the voltage is gradually increased), the second control unit 248 may disable the DC voltage supply unit 226. As a result, the DC voltage supply unit 226 may be also controlled to stop charging the battery 260, and thus the safety in using the charge device 200 is further improved.

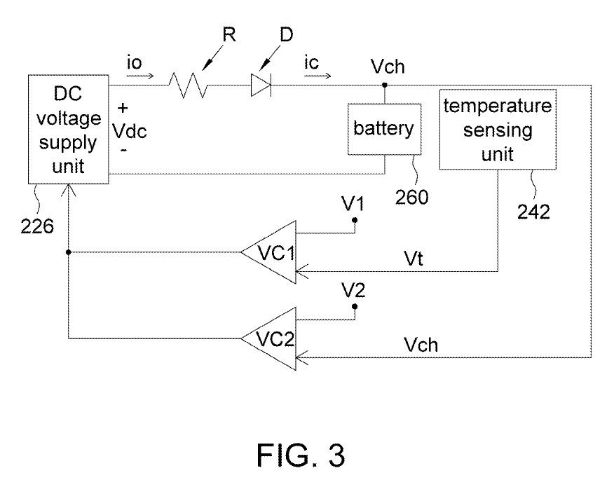

FIG. 3 is a schematic diagram showing a circuit of the charge device 200 in FIG. 2 according to an embodiment of the invention.

In this embodiment, the temperature sensing unit 242 may include a thermistor disposed adjacent to a surface of the battery 260, and the resistance of the thermistor varies with the surface temperature correspondingly. As a result, the temperature sensing unit 242 may generate a sensing voltage Vt corresponding to the surface temperature of the battery 260 according to the resistance of the thermistor.

The first control unit 244 may include a first voltage comparator VC1 for comparing the sensing voltage Vt generated by the temperature sensing unit 242 after the temperature sensing unit 242 senses the surface temperature of the battery 260 and a first predetermined voltage V1. As a result, the first control unit 244 determines whether the surface temperature is higher than the predetermined temperature according to a comparison result of the first voltage comparator VC1.

The second control unit 248 may also include a second voltage comparator VC2 for comparing the battery voltage Vch and a second predetermined voltage V2. As a result, the second control unit 248 determines whether the battery voltage Vch is higher than the second predetermined voltage V2 according to the compare result of the second voltage comparator VC2.

In this embodiment, the current limiting element 222 is realized via a resistor R, and the rectifier element 224 is realized via a diode D. The resistor R and the diode D are connected in series between the DC voltage supply unit 226 and the battery 260.

The DC voltage supply unit 226 is used for providing a DC voltage Vdc. The DC voltage Vdc provided by the DC voltage supply unit 226 charges the battery 260 via the resistor R and the diode D. The DC voltage supply unit 226 may be realized via a DC-DC convertor or an AC-DC convertor. The DC voltage Vdc provided by the DC voltage supply unit 226 may be set according to different types of the battery 260.

The resistor R may be used for limiting the charge current ic of the battery 260. When the battery voltage Vch is higher than the DC voltage Vdc, the diode D may avoid a misoperation by preventing the current from flowing from the battery 260 back to the DC voltage supply unit 226.

How to determine the DC voltage Vdc provided by the DC voltage supply unit 226 and the resistance value of the resistor R is illustrated with an example as follows. In this embodiment, it is supposed that a saturation voltage of the battery 260 (that is, the highest battery voltage Vch of the battery) is 12.6 volts (V), a discharge cut-off voltage of the battery (that is, the lowest battery voltage Vch of the battery) is 11 V, and the upper limit of the charge current ic is 600 milliampere (mA).

First, the DC voltage Vdc may be correspondingly designed according to discharge cut-off voltage whose value is 11 V. To avoid that the energy is consumed at the resistor R, the DC voltage Vdc should not be designed too high. Additionally, the DC voltage Vdc should not be designed too low. Otherwise, the battery 260 is not easily charged. As a result, the DC voltage Vdc provided by the DC voltage supply unit 226 may be designed to be 13V.

Moreover, if the voltage across the diode D is 0.5V, according to the upper limit of the charge current ic which is 600 mA, the resistor R may be correspondingly designed to be 2.5 ohm obtained according to the following equation: (13−0.5−11)/0.6=2.5 ohm.

After the resistor R is determined, the upper limit of the charge current ic may be limited to 600 mA. As a result, in the charge process, the battery voltage Vch of the battery 260 becomes higher and higher. If the battery voltage Vch of the battery 260 is increased to 12V, the charge current ic is 200 mA at that moment obtained according to the following equation: (13−12.5)/2.5=200 mA. As a result, the charge current ic becomes lower and lower along with the increase of the battery voltage Vch of the battery, which conforms with the need of a charge principle.

Additionally, if the battery 260 is designed to be capable of being charged to allow the battery voltage Vch to reach the saturation voltage 12.6V, the DC voltage Vdc provided by the DC voltage supply unit 226 may be designed to be 13.1V obtained according to the following equation: 12.6+0.5=13.1V. Afterwards, the value of the resistor R is correspondingly re-determined to allow the upper limit of the charge current ic to be 600 mA.

Furthermore, if the battery voltage Vch of the battery 260 is abnormal and increased to exceed the DC voltage Vdc provided by the DC voltage supply unit 226 in the charge process, and for example, the battery voltage Vch is increased to 13.5V, the diode D is off to prevent the current flowing from the battery 260 back to the DC voltage supply unit 226 at that moment.

As a result, if different types of batteries (the batteries with different rated voltages or different types of the batteries such as lithium batteries or nickel-hydrogen batteries) are charged, the resistor R with different resistances may be used according to the designed value of the charge current.

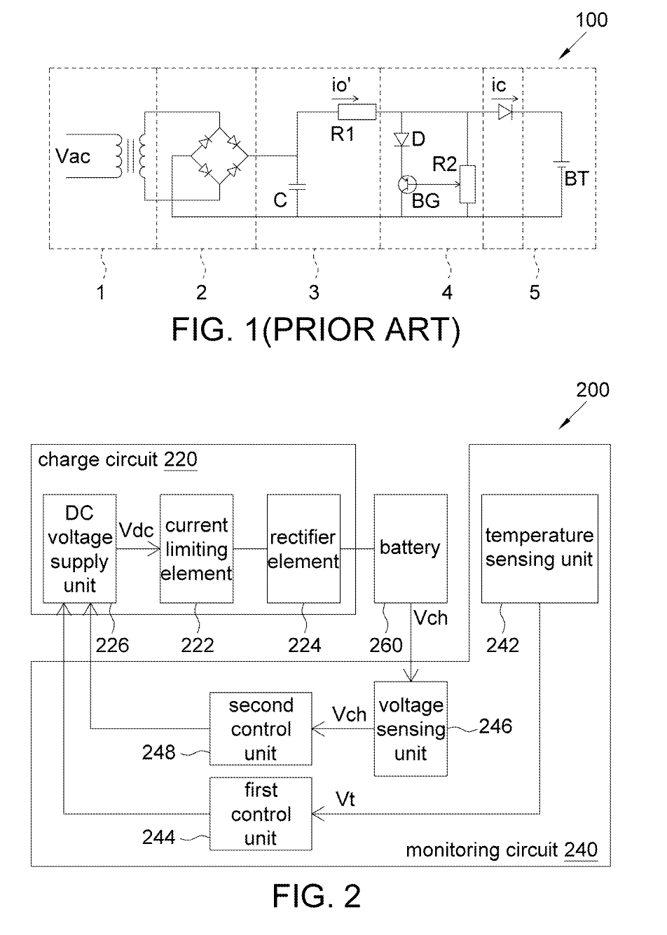

In contrast with the charge device 100 in FIG. 1, the DC voltage Vdc provided by the DC voltage supply unit 226 in this embodiment is converted to an output current io, and the output current io is substantially equal to the charge current ic. In other words, the output current io provided by the charge device 200 is entirely used to charge the battery 260. Therefore, the energy utilization of the charge device 200 is improved, and the charging efficiency is improved.

Furthermore, as shown in FIG. 2, the charge circuit 220 does not use the shunt circuit 4. Consequently, in contrast with the conventional charge device 100 in FIG. 1, the complexity of the circuit of the charge device 200 is reduced in this embodiment, and the charge circuit 220 has advantages such as less components, lower power consumption, and lower cost. Moreover, the charge device 200 in this embodiment can improve the safety in charging due to the monitoring circuit.

Additionally, in another conventional method, the charge device uses a charge controller to charge the battery. The charge controller has complex circuits and various functions, and it may control the charge current and a charge voltage of the battery stably. However, the charge controller is complex and has high cost.

In the charge device 200 according to the invention, the DC voltage supply unit 226 is preferred to be a voltage source circuit without current limiting output such as a linear power supply circuit or a switching power supply circuit utilizing pulse width modulation (PWM). In other words, the charge device 200 according to the invention may not use the charge controller, and thus the complexity of the circuit is not increased, and the cost is reduced.

Furthermore, if the resistance of the resistor R is determined according to the value of the charge current, different types of the batteries can be charged. As a result, the flexibility of designing the circuit can be improved. Additionally, the DC voltage supply unit 226 may generate the DC voltage Vdc for charging the battery 260 not only in an AC-DC converting mode, but also in a DC-DC converting mode. In other words, as long as the charge device 200 can provide the DC voltage Vdc higher than the battery voltage Vch, it can charge the battery 260. Consequently, the flexibility of designing the circuit can be further improved.

The charge device according to the embodiment of the invention can improve the utilization of the energy, improve the charging efficiency of the charge device, and simplify the circuit of the charge device. Additionally, the charge device utilizes the temperature sensing unit to sense the surface temperature of the battery, which can prevent the charge device from charging the battery when the surface temperature of the battery is abnormal. As a result, the safety in the process of charging the battery via the charge device can be improved. Furthermore, the charge device according to the invention has advantages such as quick charge and better flexibility of designing the circuit.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A charge device for charging a battery, comprising:
a charge circuit including:
a current limiting element;
a rectifier element connected with the current limiting element in series; and
a direct current (DC) voltage supply unit for providing a DC voltage to the battery to charge the battery via the current limiting element and the rectifier element connected with the current limiting element in series; and
a monitoring circuit connected with the battery and the charge circuit, respectively, wherein the monitoring circuit includes:
a temperature sensing unit for sensing a surface temperature of the battery; and
a first control unit controlling the DC voltage supply unit to stop charging the battery when the surface temperature is higher than a predetermined temperature.

2. The charge device according to claim 1, wherein the first control unit comprises:
a first voltage comparator for comparing a sensing voltage generated after the temperature sensing unit senses the surface temperature of the battery with a first predetermined voltage;
wherein the first control unit determines whether the surface temperature is higher than the predetermined temperature according to a compare result of the first voltage comparator.

3. The charge device according to claim 1, wherein the monitoring circuit further comprises:
a voltage sensing unit for sensing a battery voltage across two ends of the battery; and
a second control unit for controlling the DC voltage supply unit to stop charging the battery when the battery voltage is higher than a second predetermined voltage.

4. The charge device according to claim 3, wherein the second control unit comprises:
a second voltage comparator for comparing the battery voltage and the second predetermined voltage;
wherein the second control unit determines whether the battery voltage is higher than the second predetermined voltage according to a compare result of the second voltage comparator.

5. The charge device according to claim 1, wherein the temperature sensing unit comprises a thermistor disposed adjacent to a surface of the battery, the resistance of the thermistor correspondingly varies with the surface temperature, and the temperature sensing unit generates a sensing voltage corresponding to the surface temperature of the battery according to the resistance of the thermistor.

6. The charge device according to claim 1, wherein the current limiting element is a resistor.

7. The charge device according to claim 1, wherein the rectifier element is a diode.
